(19) United States
(12) Patent Application Publication
(10) Pub. No.: US 2026/0043326 A1
(43) Pub. Date: Feb. 12, 2026

(54) ADAPTIVE DIFFERENTIAL PHASE TIME SEMBLANCE FOR CEMENT BOND EVALUATION

(71) Applicant: Halliburton Energy Services, Inc., Houston, TX (US)

(72) Inventors: Frederico HELOUI DE ARAUJO, Rio de Janeiro (BR); Ruijia WANG, Singapore (SG); Yao GE, Singapore (SG); Brenno Caetano Troca CABELLA, Rio de Janeiro (BR)

(73) Assignee: Halliburton Energy Services, Inc., Houston, TX (US)

(21) Appl. No.: 18/796,145

(22) Filed: Aug. 6, 2024

(51) Int. Cl. E21B 47/005; G01V 1/18; G01V 1/50

(52) U.S. Cl. CPC E21B 47/005; G01V 1/186; G01V 1/50; G01V 2210/6222

(57) ABSTRACT

Methods and systems of the present disclosure include removing the effects of certain types of noise from collected data that may affect the accuracy of determinations made using the collected data. Such methods may be used to separate data associated with acoustic energy traveling along a casing from other data included in a dataset. “Data of interest” may be identified based on known modes of energy propagation through a wellbore casing. The velocities of energy traveling along a wellbore casing may be known based on known characteristics of the casing. Data associated with acoustic wave modes not related to the casing may be removed from the dataset. The data of interest may then be evaluated when cement bond index values are assigned to different portions of the casing. The casing may be placed into operation when the cement bond index values of the casing correspond to an acceptance criterion.

### TECHNICAL FIELD

The present disclosure is generally directed to improving determinations made from collected data such that a wellbore may be operated more safely. More specifically, the present disclosure is directed to separating data from a dataset based on temporal characteristics of portions of data included in the dataset.

### BACKGROUND

Acoustic devices such as hydrophones may be deployed in a wellbore to collect sounds that may be used to identify whether a wellbore is safe to operate. Apparatuses like a hydrophone array may include many acoustic sensors or water-resistant microphones that sense wellbore sounds. Hydrophones deployed in a wellbore may sense noises from many sources or may sense sounds from a sound source that has traveled through one or more mediums (e.g., a wellbore casing or along a wellbore tube).

Casings that are installed in a wellbore must be cemented in place for the wellbore to function in a safe and environmentally conscious manner. Methods for verifying how well a wellbore casing is attached to strata that surround the wellbore may evaluate data (e.g., acoustic data) that was collected in the wellbore. Noises from other sources or noises that travel through different mediums other than the wellbore casing may cause cement bond quality evaluations to be inaccurate. This is because noises other than sounds associated with the acoustic waves that travel through the wellbore casing may obfuscate data critical to determining how well the casing is cemented to surrounding strata.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology.

FIG. 2 illustrates a hydrophone array that is being deployed in a wellbore, in accordance with various aspects of the subject technology.

FIGS. 3A, 3B, and 3C figuratively illustrate examples of how acoustic energy may move within and along a wellbore casing, in accordance with various aspects of the subject technology.

FIG. 4 illustrates impulses of acoustic energy sensed over time at an array of sensors, in accordance with various aspects of the subject technology.

FIG. 5 includes three different images of a hydrophone array that is deployed in a wellbore, in accordance with various aspects of the subject technology.

FIG. 6 illustrates a mapping that shows locations of different noise sources at a specific location of a wellbore, in accordance with various aspects of the subject technology.

FIG. 7 illustrates actions that may be performed by a system that senses data and that performs evaluations on the sensed data, in accordance with various aspects of the subject technology.

FIG. 8 includes an image generated from data collected by a hydrophone array, in accordance with various aspects of the subject technology.

FIG. 9 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous compounds. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

A hydrophone array may be deployed in a wellbore to collect sounds that may be used to identify whether a wellbore is safe to operate. This hydrophone array may include acoustic sensors (e.g., numerous individual hydrophones) that sense noises of various sorts and a hydrophone array may be referred to as a hydrophone sensing apparatus. For example, a hydrophone sensing apparatus that includes an acoustic transmitter and array of acoustic sensors may emit/transmit pulses of acoustic energy when collecting data that is evaluated to identify how well portions of a wellbore casing are cemented to or otherwise adhered to strata that surrounds the wellbore casing.

When a tool or assembly that includes an array of hydrophones (a hydrophone array) is deployed in a wellbore, acoustic data may be collected. This collected data may include information associated with traveling acoustic waves (the movement of acoustic energy) through specific transmission mediums. One such transmission medium may include a casing that is cemented in place in a wellbore and the acoustic waves that travel through this casing/cement medium may correspond to a first acoustic wave mode or first guided wave mode. Another transmission medium that may be associated with a tube located in the wellbore. As such, acoustic waves that travel along this tube may have characteristics of a second acoustic or guided wave mode.

Methods and systems of the present disclosure include removing the effects of certain types of noise (“unwanted noise”) from collected data that may affect the accuracy of determinations made using the collected data. Such methods may be used to separate data associated with acoustic energy traveling along a casing from other data included in a dataset (e.g., data associated with acoustic energy traveling along a tube). The “Data of interest” may be identified based on known modes of energy propagation through a wellbore casing. The velocities and/or frequencies of energy traveling along a wellbore casing may be known based on known characteristics of the casing. Data associated with acoustic wave modes not related to the casing may be removed from the dataset. The data of interest may then be evaluated when cement bond index values are assigned to different portions of the casing. The casing may be placed into operation when the cement bond index values of the casing correspond to an acceptance criterion.

Noises from other sources (e.g., road noise) or from sounds traveling alone a tube of the wellbore may mask or obscure (obfuscate) sounds indicative of how well the casing is bonded to the wellbore strata. Methods and apparatus discussed herein may be referred to as “systems and techniques” of the present disclosure. These “systems and techniques” may be used to remove unwanted noise from a dataset such that more accurate determinations may be made. In certain instances, a hydrophone array may be deployed in a tube or next to a tube when acoustic data is collected. This means that a set of collected data may include data associated with a first guided wave mode of the casing and a second guided wave mode of the tube. The presence of sound data from multiple mediums (e.g., the casing and a tube) can result in inaccurate determinations being made because it may be difficult to separate unwanted noise from sounds traveling along the casing of a wellbore. In instances when a tube is eccentric, eccentricities of the tube may affect azimuthal mappings or responses of a sensing system. Since techniques of the present disclosure are directed to separating sounds of one acoustic wave mode from a set of data that includes sounds from multiple acoustic wave modes, the techniques of the present disclosure improve the accuracy of determinations made by a sensing system such that safer wellbore may be built and used.

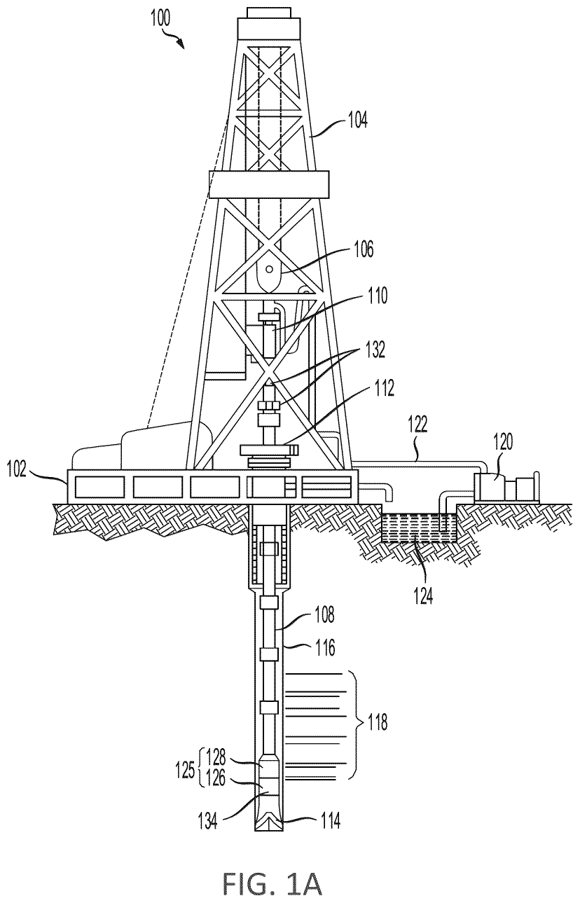

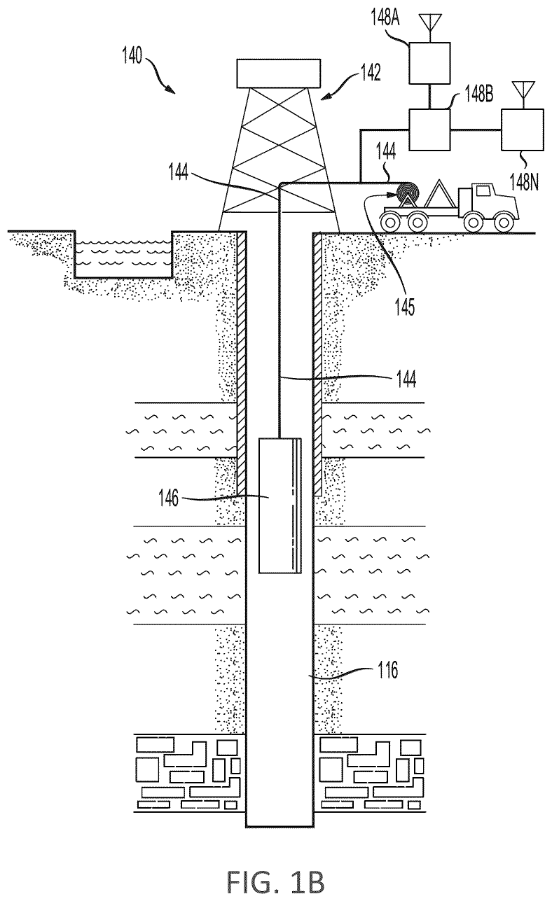

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g. acoustic sensors, EM sensors, seismic sensors, gravity sensor, sensors, etc.) that can acquire formation data, such as characteristics of the formation, components of the formation, etc. For example, the drilling arrangement shown in FIG. 1A can be used to gather formation data through an tool (not shown) as part of logging the wellbore using the tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor the performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of drill string 108 and generally resembles a very thick-walled cylindrical pipe, typically with threaded ends and a hollow core for the conveyance of drilling fluid. Multiple collars 134 can be included in drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. A tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the tools described herein.

The illustrated wireline conveyance 144 provides power and support for the tool, as well as enabling communication between data processors 148A-N on the surface. In some examples, wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. For slickline or coiled tubing configurations, power can be supplied downhole with a battery or via a downhole generator.

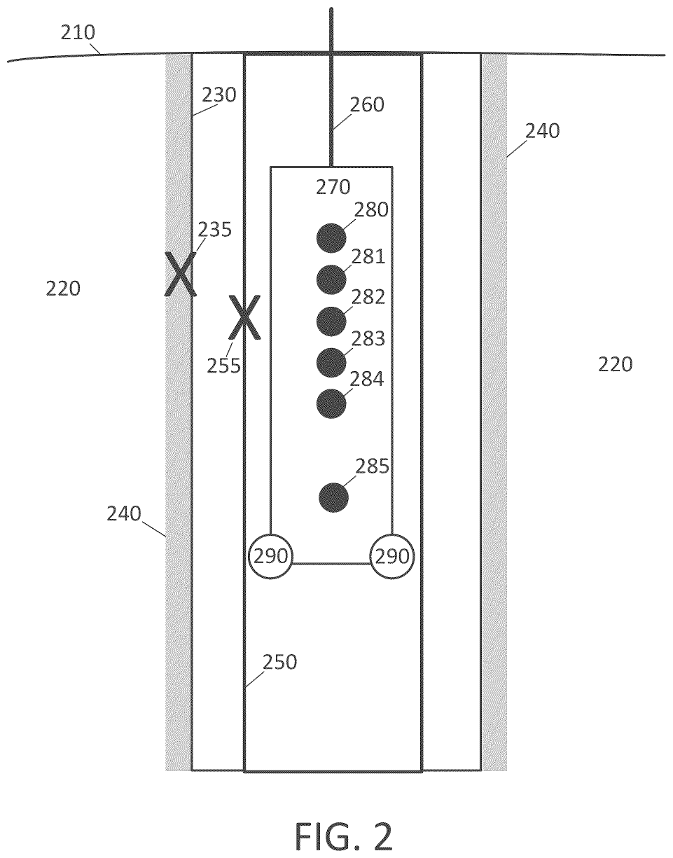

FIG. 2 illustrates a hydrophone array that is being deployed in a wellbore. FIG. 2 includes casing 230 cemented into a wellbore with cement 240, tube 250 that is deployed in casing 230, and hydrophone array 270. Hydrophone array 270 includes a plurality of sensors/microphones (280, 281, 282, 283, and 284), and bumpers 290. Deployment cable 260 may be used to lower hydrophone array 270 into the wellbore casing 230. FIG. 2 also includes ground surface 210 and subterranean strata 220 located below the surface of ground surface 210. While FIG. 2 illustrates hydrophone array 270 being deployed in tube 250, hydrophone array 270 may be deployed within a casing that does not include a tube or may be deployed next to an external surface of a tube that is located within a casing.

When hydrophone array 270 is lowered into the wellbore casing 230, bumpers 290 may rub against or bump into tube 250 and this rubbing and bumping may generate noise characteristic of hydrophone array moving within tube 250. Such bumping noises or “road noise” is one type of noise amongst other types of noise that may obscure other sounds from which determinations may be made. This means that hydrophone array 270 may sense unwanted noises from unwanted noise sources when hydrophone array 270 collects data for an apparatus that evaluates whether wellbore casing 230 is cemented properly in a wellbore. Sounds that travel through a wellbore or wellbore casing 230 travel at a wave propagation speed through one medium or another (e.g., fluids contained within a casing or along walls of the casing). As such, noises from various sources may travel along the walls of tube 250 at the wave propagation speed toward sensors (280, 281, 282, 283, and 284). Sensors 280, 281, 282, 283, and 284 may each of these sensors may respectively sense noises from different sources that are shifted in time. For example, since sensor 284 is closest to bumper 290 and since each of the other sensors (281, 282, 283, and 284) are located farther from bumper 290, road noise generated by bumper 290 will be sensed by sensor 284 first and then respectively by sensor 283, 282, 281, and 280. Road noise may also be generated by tool centralizers or other bumpers not illustrated in FIG. 2. Speeds of wave propagation may vary when the energy of those waves moves through different mediums. In certain instances, acoustic waves traveling in the walls of a structure (pipes, tube, or casing) may include multiple frequencies, where each frequency may travel at a different wave propagation speed, potentially because of a dispersive nature of the structure. Differences in time that the road noise or other noise is shifted may vary based on the wave propagation speed in mediums that the noise travels through. When sensors 283, 282, 281, and 280 are separated by a specific distance, the times that specific noise signals reach specific sensors may be used to identify a velocity of particular noise signals. While bumpers 290 are illustrated at a lower end of hydrophone array 270, other bumpers may be located at an upper end of the hydrophone array. Hydrophone array 270 includes acoustic transmitter 285 that may be used to transmit pulses of acoustic energy when evaluations are performed. For example, when cement bond index (CBI) values of a wellbore are evaluated.

Sound traveling from a sound source along the tube or other structure (e.g., casing 230) may travel within the wall of the tube 250 or other structure, may travel in a fluid medium adjacent to the tube or other structure (e.g., casing 230), or may travel through both. When the hydrophone array is deployed in a wellbore, sounds sensed by sensors of the hydrophone array may be used to detect sounds that are associated with a wellbore defect. A defect (e.g., a crack) in a tube 250 (defect 255) or in a casing 230 (defect 235) of the wellbore may generate sounds as fluids leak through such defects. FIG. 2 includes two different defects, identified with X marks, a first defect 235 may be a crack in cement 240 and in casing 230, and a second defect 255 may be a crack in tube 250. Since sensors 280, 281, 282, 283, and 284 of hydrophone array 270 may sense noise from a leak and sense road noise at the same time, techniques that effectively filter out or that suppress (attenuate) noises allow for determinations relating to defects to be identified more easily. Additionally, or alternatively, sounds associated with traveling acoustic waves or the movement of acoustic energy along a wellbore casing may be used to determine how well that casing is bonded to strata of a wellbore.

Noise traveling from a bottom portion of hydrophone array 270 (e.g., road noise) will travel upward toward the array of sensors (280, 281, 282, 283, and 284) of hydrophone array 270 at the wave propagation speed. This means that each of the sensors (280, 281, 282, 283, and 284) will sense the road noise at different times and that signals generated by receipt of the road noise by the sensors will be offset in time. The timing offsets are a function of the wave propagation speed. To some extent, the same may be true for sounds generated by leaks in a tube or other wellbore structure. Since defect 255 is located near a center portion of the array of hydrophone sensors (280, 281, 282, 283, and 284), sounds associated with such leaks will not be offset in the same direction as sounds that propagate from one end of hydrophone array 270 to another end hydrophone array 270. Since defect 255 is located in the middle of the sensor array, sound generated by fluids leaking through defect 255 will first be received by sensor 282, after which sensors 281 and 283 will receive the leaking sound, and then the leaking sound will be received by sensors 280 and 284. As such, some sound energy from defect 255 travels upward and some sound energy from defect 255 travels downward.

Based on the position of defect 235 relative to the location of hydrophone array 270, leaking sounds received by the sensors of the hydrophone array will be received in the following order: first sensor 281 will receive the leaking sound, then sensors 280 and 282 will receive the leaking sound, next sensor 283 will receive the leaking sound, and then sensor 284 will receive the leaking sound.

This means that some noises (e.g., road noise) received by the sensors (280, 281, 282, 283, and 284) may always be shifted in time in the same direction while some portion of sounds of interest from a source next to the hydrophone array 270 may travel in opposite directions. In instances when bumpers are located at the top of hydrophone array 270, road noise may travel from an upper portion of the hydrophone array toward the bottom of the hydrophone array. Furthermore, noises from other sources may be received by hydrophone array 270, and each of these other noises may be received at respective sensors of hydrophone array 270 based on mediums that the sounds traveled through. For example, hydrophone array 270 may be located next to a tube, and noises traveling along this tube may travel at velocities associated with the tube and/or fluids within that tube. As such, when evaluations are preformed to verify the integrity of cement 240 that bonds casing 230 to subterranean strata 220, noise that travels along a tube or other wellbore structure may interfere with determinations made by a system that evaluates the quality of cement bonding.

Hydrophone array 270 may include one or more acoustic transmitters 285 that transmit acoustic energy as well as a plurality of sensors (e.g., sensors 280-284) that sense acoustic energy (sonic or ultrasonic). In certain instances, an acoustic energy transmitter may be directional or steerable. In other instances, an acoustic energy transmitter may not be directional or steerable. When a cement bonding verification process is performed, pulses of acoustic energy may be transmitted from transmitter 285 of hydrophone array 270. Once such pulses are transmitted, a portion of the energy of these pulses may travel along casing 230 in the form of acoustic sounds. Each of sensors 280-284 may sense the sound as it travels along casing 230 when acoustic data is collected. Evaluations may be performed on this collected data when CBI values of the wellbore are identified. These CBI values may be used to determine whether or not a wellbore casing is properly cemented into a wellbore. Acoustic energy may travel from the transmitter to the receiver via several different paths and each of these paths may be referred to as a specific mode. Even inside the wall of a casing, there may be different modes of energy movement, in such an instance, each mode may have a different frequency and velocity. When a dataset that includes multiple modes associated with a wellbore casing, each of these different modes may be separated when analysis consistent with the present disclosure is performed.

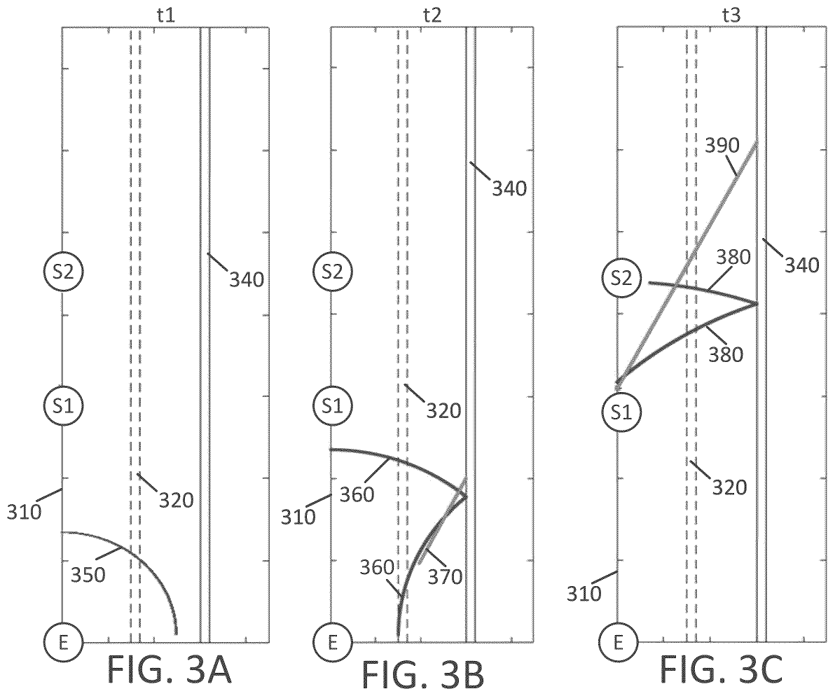

FIGS. 3A, 3B, and 3C illustrate a semi-cross-sectional view of an exemplary wellbore where a hydrophone array is deployed. Each of FIGS. 3A, 3B, and 3C include acoustic transmitter E and sensors S1 & S2 of hydrophone array 310. Each of FIGS. 3A, 3B, and 3C also include tube 320 and casing 340 that is cemented in place in a wellbore. Note that in this instance, hydrophone array 310 is deployed within casing 340 next to tube 320. FIGS. 3A, 3B, and 3C show propagation of transmitted acoustic energy and “guided wave” signals associated with the transmitted acoustic energy at respective times t1, t2, and t3. For example, time t1 may correspond to 0.083 milliseconds (ms), time t2 may correspond to 0.15 ms, and time t3 may correspond to 0.286 ms after an acoustic pulse was transmitted.

FIGS. 3A, 3B, and 3C figuratively illustrate examples of how acoustic energy may move within and along a wellbore casing. FIG. 3A shows acoustic energy 350 propagating away from transmitter E at time t1 after a pulse of acoustic energy was transmitted from transmitter E. As the transmitted acoustic energy propagates toward tube 320 and casing 340, that energy will impact an internal wall of the casing generating guided wave signals that propagate along the casing. To reach sensors of a hydrophone assembly, portions of the acoustic energy that travels along the casing as guided waves exits or escapes the casing as those guided waves move along the casing. Because of this, casing related guided waves that are sensed by the sensors of the hydrophone may be referred to as “leaky-guided waves.” FIG. 3B shows acoustic energy 360 and leaky-guided wave signal 370 at a time t2 after the pulse was transmitted from transmitter E. Similarly, FIG. 3C shows acoustic energy 380 and leaky-guided wave signal 390 at a time of t3 after the pulse was transmitted from transmitter E. As such, FIGS. 3A, 3B, and 3C show that sounds associated with the transmitted pulse and sounds associated with guided waves induced in casing 340 are sensed by sensors S1 & S2. Since energy of the transmitted acoustic pulse and the guided waves move through different mediums, energy of the transmitted acoustic pulses and the leaky-guided waves will be sensed at sensors S1 & S2 within relative timing that corresponds to at least two different transmission modes. This also means that sound waves of the transmitted acoustic pulse will tend to have a different velocity than the guided waves that travel along casing 340. Methods of the present disclosure may remove energy associated with all modes of energy transfer through a tube. For example, a tube within which a hydrophone array is deployed in a wellbore. This means that the techniques of the present disclosure may suppress all modes of acoustic waves sensed by sensors of a hydrophone. While FIGS. 3A-3C show leaky-guided wave signals 370 and 390, these wave signals do not necessarily correspond to all wave modes that casing 340 may have. As such FIGS. 3A-3C do not show all of the leaky-guided wave modes that may be sensed by sensors S1 & S2.

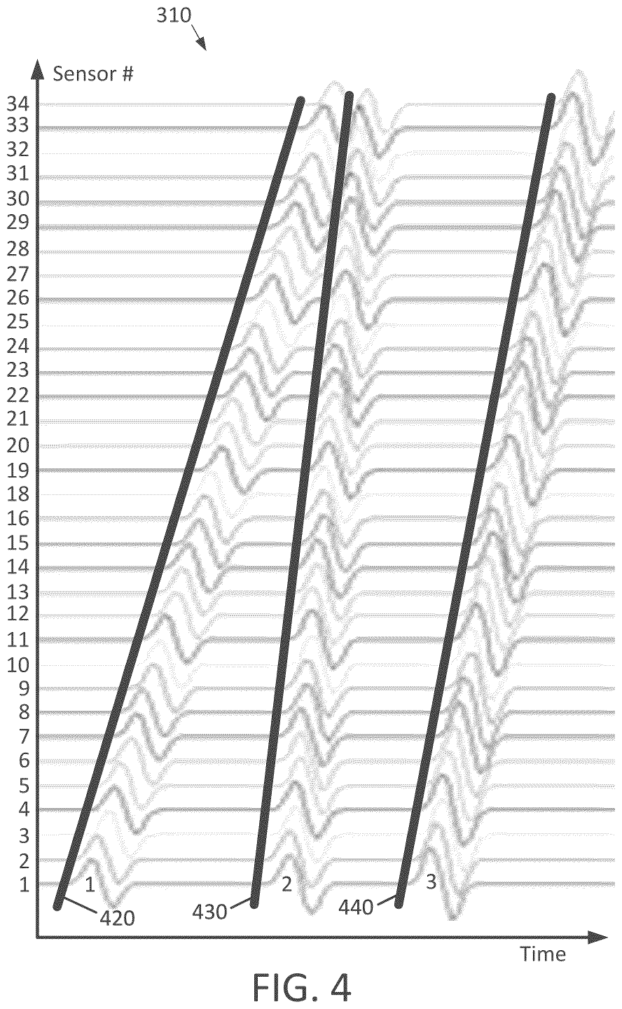

FIG. 4 illustrates impulses of acoustic energy sensed over time at an array of sensors. FIG. 4 shows energy sensed by respective sensors (sensor 1 through sensor 34) over time. As such FIG. 4 includes a vertical axis that shows changes in energy received at each sensor of a hydrophone. FIG. 4 also includes a horizontal axis of time. Since each respective sensor of the hydrophone may be separated from a next sensor of the hydrophone by a separation distance D, velocities or other values of propagation may correspond to how a wave of a particular energy pulse is received respective sensors. An example of other propagation values may be termed “slowness values,” and respective slowness values may be proportional to the inverse of specific velocity values. As such, slowness value SL1 may equal X times the inverse of velocity value 1 (V1), or SL1=X (1/V1), where X is a proportionality value or constant.

Each respective sensor (sensors 1-34) senses what may appear to be three groupings of pulses. Numbers 1, 2, and 3 that appear next to lines 420, 430, and 440 represent that there are three different acoustic wave modes included in FIG. 4. FIG. 4 illustrates acoustic energy sensed by respective sensors at different times and energy associated with more than one of these three acoustic wave modes may be associated with transmission of signals along a same medium (e.g., along the medium of a wellbore tube). Since theses sensors are separated by the same distance, a velocity that these pulses travel correspond to the separation distance D divided by a difference in the amount of time separating the moment in time that a pulse was sensed by one sensor (e.g., sensor number 1) and a next sensor (e.g., sensor number 2). Lines 420, 430, and 440 correspond to velocities that each respective pulse was sensed at each respective sensor. Since each of the slopes of lines 420, 430, and 440 are different slope, each of the pulses (pulses number 1, 2, and 3) travel between different sensors at different velocities. Each of these different pluses may have been generated by a different noise source or may have been generated by a same noise source and then traveled through a different medium (e.g., along a wellbore casing or a set of wellbore tubing) before reaching a particular sensor. Like above, each of these velocities may have a slowness value that corresponds directly to a velocity or be inversely proportional to a velocity.

Since the velocity that sound travels through different mediums varies and since the slopes of lines 420, 430, and 440 each correspond to a different velocity, in an instance when acoustic energy is used to excite a resonance in a wellbore casing, one set of acoustic waves received by sensors of a hydrophone should correspond to acoustic energy traveling along the wellbore casing (a first acoustic or specific “guided wave mode”). In FIG. 4, the pulses along line 430 correspond to acoustic waves traveling according to an acoustic wave mode (or “guided wave mode”) of the casing. Of the various pulses of acoustic energy sensed by sensors 1-34, only the acoustic pulses associated with the guided wave mode of the casing (e.g., slope of line 430) should be evaluated when making determinations regarding how well the casing is cemented to strata that surrounds a wellbore. As such, only data that corresponds to acoustic pulses of line 430 should be analyzed when CBI values are assigned to the wellbore.

The process of assigning CBI values to a wellbore may include collecting data along a wellbore. This may include transmitting acoustic pulses from a hydrophone array, collecting sensed data, moving the hydrophone array, and repeating this process along the wellbore. This movement of the hydrophone array may include rotating the hydrophone array and/or moving the hydrophone array along the wellbore (e.g., up or down). Evaluations may be performed from the collected data when CBI values are assigned to respective portions of the wellbore. Such evaluations may be performed as the data is collected or may be performed after the data has been collected. Once identified, respective CBI values as well as other data may be stored in a CBI log. Further evaluations may be performed to identify whether these CBI values correspond to a casing that can be placed into operation. As such, the evaluations discussed in this disclosure may be required before a wellbore can be put into service. In instances when certain locations of the wellbore are determined to appear to have poor adhesion, a repair operation may be initiated. Alternatively, a determination may be made (based on a criteria) that the location where the apparent poor adhesion is located is acceptable. Bonding evaluations may also be performed at the end of the life of a wellbore to make sure that a plug and abandonment process can be completed safely based on an end-of-life cycle criterion. Such a plug and abandonment process may evaluate cement bond logs to identify areas of the wellbore that should be plugged to isolate respective zones of the wellbore to prevent fluids from moving from one zone (e.g., depth) of the wellbore to another zone of the wellbore. An end-of-life criterion may require that cement bond logs be collected and data from those logs should be evaluated to identify locations of the wellbore where plugs (e.g., cement plugs) should be placed to prevent flids from one zone of the wellbore moving to another. For example, areas of the wellbore that have lower CBI values (e.g., less than decommission CBI a threshold value) may be isolated from areas of the wellbore that have higher cement bond index values (e.g., higher than the decommission CBI value). Additionally, or alternatively areas of the wellbore that are near strata where water is located may be isolated from areas of the wellbore that are near strata where oil is located by plugging the wellbore at specific depths.

When a repair is determined to be required, a hole may be drilled in the casing and cement may be forced through that hole to fix an apparent cement bond defect. Criteria for determining whether a wellbore is fit for service may include identifying that all CBI values of the wellbore at least meet a threshold level or may identify that areas where a CBI value does not meet that threshold corresponds to a void or defect size that is below a defect threshold size. This may be because small defects or voids in cement are known to have a low probability of adversely affecting the operation of the wellbore during its lifespan.

Once energy associated with the acoustic wave mode (guided wave mode) of the casing is identified, the data collected by operation of the hydrophone array may be filtered by removing data associated with other wave modes (e.g., wave modes associated with lines 420 and 440). Alternatively, data associated with line 430 (the acoustic wave mode of the casing) may be extracted from the collected data.

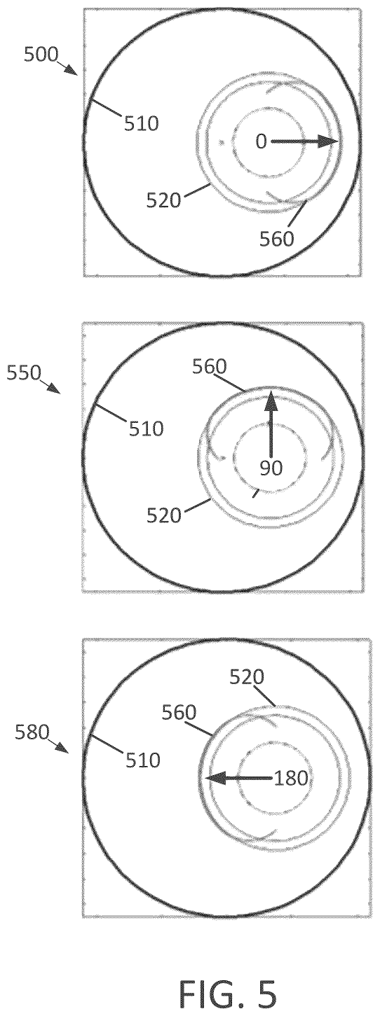

FIG. 5 includes three different images of a hydrophone array that is deployed in a wellbore. These three different images (500, 550, and 580) depict cross-sectional images of a wellbore casing 510 and tube 520 within which a hydrophone array is deployed. Images 500, 550, and 580 are each made from a perspective that looks down wellbore casing 510. The images of FIG. 5 show that a hydrophone array may be deployed in tube of a wellbore. Note that tube 520 is not located at the center point of wellbore casing 510. Note that the hydrophone array of FIG. 5 is not located at the center point of wellbore casing 510 as the location of hydrophone array is centered within tube 520.

In image 500, the hydrophone array is pointed in a direction that corresponds to 0 degrees (toward the right of FIG. 5), at this time hydrophone array emits acoustic energy 560. In image 550, the hydrophone array is pointed in a direction that corresponds to 90 degrees (toward the upper portion of FIG. 5), at this time hydrophone array emits acoustic energy 560. In image 580, the hydrophone array is pointed in a direction of 180 degrees (toward the left of FIG. 5), at this time hydrophone array emits acoustic energy 560. As a hydrophone array spins in tube 520, it emits pulses of acoustic energy and senses acoustic energy that may be associated with guided wave modes of tube 520 and casing 510, for example.

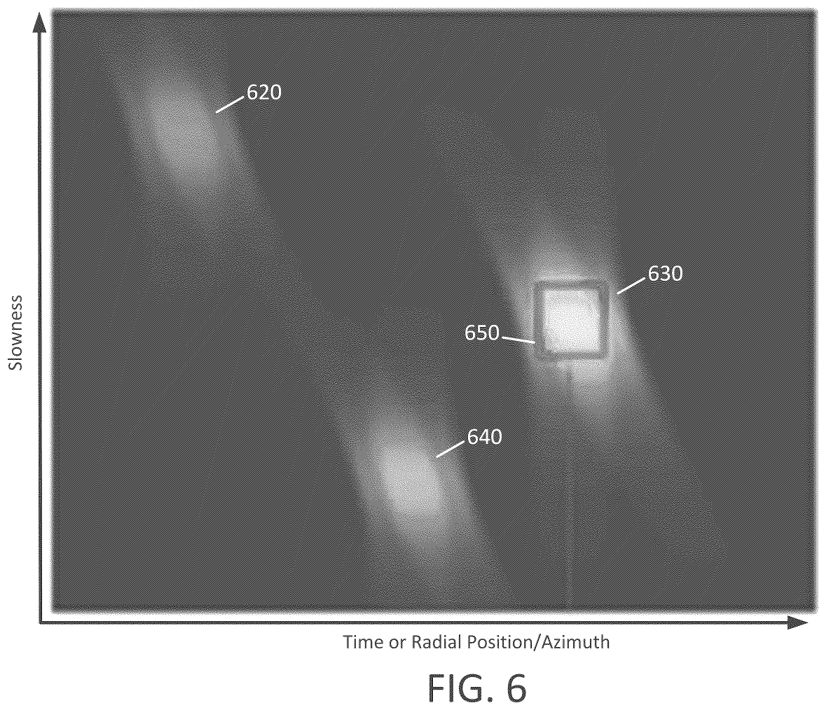

FIG. 6 illustrates a mapping that shows locations of different noise sources at a specific location of a wellbore. The mapping of FIG. 6 includes a horizontal axis of time and a vertical axis of slowness. The time axis may also correspond to a radial orientation of a hydrophone array as that assembly spins through a revolution. Since, typically, the hydrophone array spins, the azimuth or radial position of the hydrophone array may vary from 0 degrees to 360 degrees (a full revolution of the hydrophone array) over a time period that corresponds to the rotational rate of the hydrophone array. Note that FIG. 6 includes three different groupings of acoustic energy, these include grouping 620, grouping 630, and grouping 640. Each of these different groupings appear as a lobe, smudge, or smear of data that each have a different brightness. Here the higher the brightness may correspond to a higher amplitude of sensed acoustic energy. Since grouping 620 has the lowest brightness, acoustic energy associated with grouping 620 is lower than acoustic energy associated with either grouping 630 or grouping 640. Grouping 630 has the greatest brightness, this indicates that the amplitudes of received acoustic data of grouping 630 are greater than sensed acoustic amplitudes of data groupings 620 or 640.

The data of grouping 630 corresponds to a guided wave mode of the casing and box 650 is an example of an adaptive window of data that corresponds to the guided wave mode of the casing. This adaptive window may be referred to as an “adaptive time/slowness window” as this window may be bounded by values of time and slowness. Determinations may be made that data of grouping 630 corresponds to the guided wave mode of the casing based on known characteristics of the casing. For example, values of slowness or velocity of acoustic energy (e.g., acoustic traveling wave) propagation for the casing may be known from past evaluations. When evaluations are performed, only data that is included within box 650 may be used when CBI values of a wellbore are identified. The various groupings 620, 630, and 640 of data appear as smeared blotches may be an artifact of the spinning hydrophone array. This is because the spinning motion of the hydrophone array may cause the hydrophone array to vibrate or move. For example, the hydrophone array may move from side to side, up and down, and/or wobble. Such vibrations or movement of the hydrophone array may result in sensed data being spread out.

Strata or formations that surround a wellbore may interfere with data of a guided wave mode associated with a casing. Since sounds of different frequencies may travel along a wellbore casing at different velocities or different slowness values, each of these different frequencies may correspond to a different acoustic wave mode of the casing. In certain instances, such effects may adversely affect a certain frequency range more than another frequency range. As such, when a casing is known to have multiple acoustic wave modes (e.g., a first acoustic wave mode and a second acoustic wave mode), data belonging to one of these acoustic wave nodes that is more likely to be affected by the strata surrounding the wellbore may be removed from a dataset.

While techniques of the present disclosure may use an analytical model to perform evaluations, determinations made by operation of the analytical model may be enhanced when an adaptive time/slowness window is used. Any imprecision in estimating the slowness or velocity of a guided wave mode of the casing may be corrected by using the adaptive time/slowness window. In certain instances, the size of the time/slowness window maybe varied when multiple evaluations are performed. Evaluations performed based on such variances in the adaptive time/slowness window may be used to identify the dimensions of a preferred window time/slowness window. The size of this window may be adjusted based on known eccentricities of a spinning hydrophone array or a with a wellbore tube.

In eccentric configurations, it may be expected that the time of arrival of the guided wave mode changes over the azimuth. The larger the eccentricity of one tube versus another, for example, may result in greater changes in arrival times over the azimuth for the tube that has the larger eccentricity. Eccentricities of the tube may result in apparent shifts in acoustic wave velocity or slowness values over the azimuth. Due to the adaptative window, a time shift associated with this time of arrival can be compensated for. This may result in increased signal to noise ratio (SNR) as compared to other approaches. Compensations applied in the adaptative time/slowness window to correct for eccentric effects provides information that can be used to estimate how much a set of tubing is eccentric.

Such eccentricities may correspond to a measure of how far a center point of a tube through which a hydrophone assembly is deployed in a wellbore is offset from a center point of the casing. When the center point of the tube is located at the center point of the casing, an eccentricity value will correspond to a value of zero percent (0%). Measures of eccentricity may vary based on how far offset the tube is offset from a center of the casing. An eccentricity value of 100% may correspond to a tube/casing offset that results in an outer surface of the tube touching an inner surface of the casing. Since an eccentricity value may vary from a value of 0% to a value of 100%, a value of 50% would indicate that the center point of the tube is offset from the center of the casing by half of the largest possible offset for given casing inner radius and a given tube outer radius. To identify these eccentricities more specifically, an offset direction in measures of degrees may also be required. When both the casing and the tube have essentially circular cross-sectional shapes, eccentricity metrics of 25% at 90 degrees identify how much the tube is offset from the center of the casing and in what direction that the tube is offset. Evaluations may be performed that compare shifts in slowness (or velocity) values of a tube to shifts in slowness (or velocity) values of a casing. An amount of timing shift associated with the tube as compared to an amount of shift associated with the casing may be used to refine estimates of eccentricity of a tube. As such, timing shifts across the azimuth of a hydrophone array may be used to identify a first estimate of eccentricity of a tube based on a wave mode associated with the tube. This estimate may be refined by timing shifts across the azimuth of the hydrophone array based on a wave mode associated with the casing. Further refinements may have to be made when the location of the varies over wellbore depth.

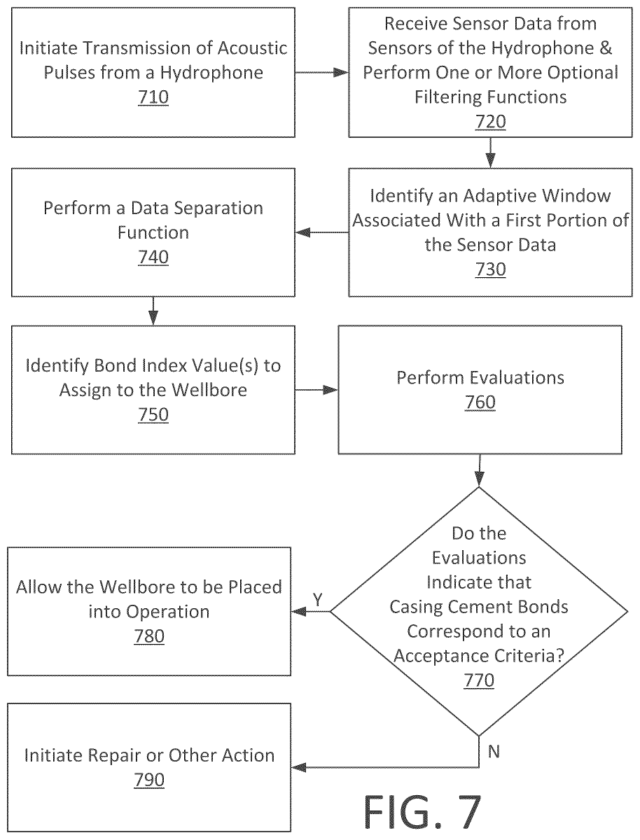

FIG. 7 illustrates actions that may be performed by a system that senses data and that performs evaluations on the sensed data. At block 710, the transmission of acoustic pulses from a hydrophone array may be initiated. This may be performed when the hydrophone array is deployed in a wellbore. A portion of the energy of the transmitted acoustic pulses may move along a wellbore casing according to a first acoustic wave mode. Sensors of the hydrophone array may sense acoustic energy as that energy moves through one or more mediums (e.g., a casing, tubing, and/or fluid in the casing) of the wellbore. This sensed acoustic data may be accessed or received by a computer of the data collection and evaluation system at block 720. One or more filtering operations may be also performed on the collected data at block 720. Examples of types of filtering operations that may be performed at block 720 include a frequency and space (F-K) filtering function, a differential phase time semblance (DPTS) filtering function, and or a differential phase frequency semblance (DPFS) filtering function.

At block 730, an adaptive time/slowness window associated with a portion of the sensor data may be identified. The process may include analyzing collected data to identify portions of data that corresponds to acoustic energy moving according to an acoustic wave mode of the casing. As mentioned above in respect to FIG. 4, this may be based on a velocity or slowness of sensor data that corresponds to known velocity or slowness values of a wellbore casing. Data associated with other acoustic wave modes may be removed from the sensor data such that only sensor data that corresponds to the known velocity or slowness of the wellbore casing be evaluated when CBI values of the wellbore are identified. Once boundaries of the adaptive time/slowness window have been identified, a data separation function may be performed at block 740. The boundaries of the adaptive time/slowness window may correspond to a range of velocity or slowness values and a range of time values. The adaptive time/slowness window, box 650 of FIG. 6 includes an upper slowness boundary, a lower slowness boundary, a first-time boundary, and a second-time boundary.

At block 750 CBI values to assign to at least a portion of the wellbore may be identified. As mentioned above, a data acquisition process may include analyzing data as it is collected or may include analyzing a set of previously collected data. The actions of blocks 710 through 750 may be repeated when data associated with various directional angles and wellbore depths are collected and processed. As such a hydrophone sensing system that, for example, includes a hydrophone array and processing elements (e.g., a computer) may collect and evaluate data from which cement bond index values are identified which in turn allows visualizations (images) of those cement bond index values to be made. In some instances, each pixel in a cement bond visualization may correspond to a single sequence of actions that corresponds to actions of blocks 710 through 750 of FIG. 7. At block 760, evaluations may be performed to identify whether the casing is sufficiently adhered to strata that surrounds the wellbore such that the wellbore may be safely placed into operation. Determination block 770 may determine whether the evaluations indicate that the cement bonds correspond to an acceptance criterion. As mentioned above, in one example, such criteria may include identifying that all areas of the wellbore have at least a threshold value of CBI. In another example, when a particular location of the wellbore has a CBI value that is lower than a CBI threshold value, the wellbore may be placed into operation when a void or defect in the cement is smaller than a defect size threshold.

When determination block 770 identifies that the casing cement bonds correspond to an acceptance criterion, the wellbore may be placed into operation at block 780. This determination may cause a message to be sent to operating personnel or a regulatory body that oversees wellbore operations. Alternatively, when determination block 770 identifies that the cement bonds do not correspond to the acceptance criterion, program flow may move to block 790 where a repair of the wellbore or some other operation is initiated.

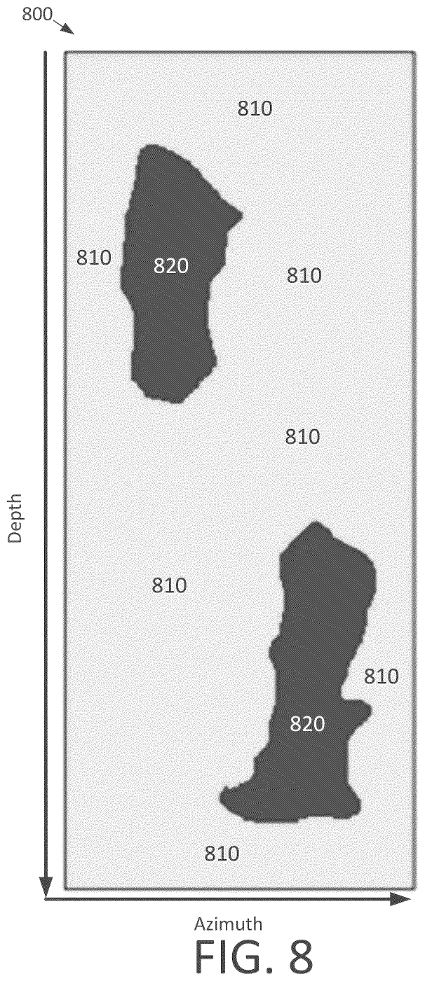

FIG. 8 includes an image/visualization generated from data collected by a hydrophone array. Image 800 of FIG. 8 shows areas 810 of a wellbore casing that are sufficiently bonded (e.g., that have CBI values that equal or are greater than a threshold value) and areas 820 of the wellbore casing that are not sufficiently bonded (e.g., that have a CBI value less than the threshold value). As such lighter colored areas 810 are bonded well and areas 820 that have a darker color are not. A criterion for placing a wellbore in operation may require that areas that are not bonded well (e.g. areas that have less than the threshold value of CBI) must be smaller than a certain size (e.g., less than 2 in square inches). Alternatively, or additionally, this criterion may identify that for a given casing length, that more than X percentage of the total square area of the casing length must have CBI values are equal to or greater than the CBI threshold value. For example, a criterion may dictate that each 10-foot length of the wellbore must have 95% of the surface area of the casing have CBI values that correspond to a well bonded casing. The vertical axis of image 800 corresponds to wellbore depth and the horizontal axis of image 800 corresponds to azimuth. As mentioned above, each pixel of a cement bond visualization may correspond to a single sequence of actions that correspond to actions 710 through 750 of FIG. 7.

Images like image 800 may be used to quantify how well an entire wellbore casing is bonded to surrounding strata such that determinations may be made regarding whether a wellbore is safe to operate. These images may also be used to identify locations of the wellbore that should be repaired. For example, the poorly adhered areas 820 may be filled with cement as part of a repair operation that injects cement or other bonding agents directly into areas 820. This may include drilling one or more access holes through the casing and injecting a bonding agent into areas 820 via the one or more holes.

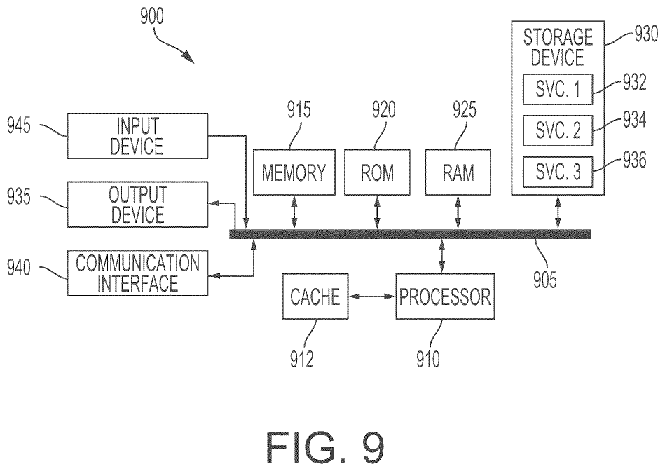

FIG. 9 illustrates an example computing device architecture which can be employed to perform any of the systems and techniques described herein. In some examples, the computing device 900 architecture can be integrated with tools described herein. The components of the computing device architecture 900 are shown in electrical communication with each other using a connection 905, such as a bus. The example computing device architecture 900 includes a processing unit (CPU or processor) 910 and a computing device connection 905 that couples various computing device components including the computing device memory 915, such as read only memory (ROM) 920 and random access memory (RAM) 925, to the processor 910.

The computing device architecture 900 can include a cache of high-speed memory connected directly with, in close proximity to, or integrated as part of the processor 910. The computing device architecture 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other computing device memory 915 may be available for use as well. The memory 915 can include multiple different types of memory with different performance characteristics. The processor 910 can include any general-purpose processor and a hardware or software service, such as service 1 932, service 2 934, and service 3 936 stored in storage device 930, configured to control the processor 910 as well as a special-purpose processor where software instructions are incorporated into the processor design. The processor 910 may be a self-contained system, containing multiple cores or processors, a bus, memory controller, cache, etc. A multi-core processor may be symmetric or asymmetric.

To enable user interaction with the computing device architecture 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art, such as a display, projector, television, speaker device, etc. In some instances, multimodal computing devices can enable a user to provide multiple types of input to communicate with the computing device architecture 900. The communications interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof. The storage device 930 can include services 932, 934, 936 for controlling the processor 910. Other hardware or software modules are contemplated. The storage device 930 can be connected to the computing device connection 905. In one aspect, a hardware module that performs a particular function can include the software component stored in a computer-readable medium in connection with the necessary hardware components, such as the processor 910, connection 905, output device 935, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCS, minicomputers, mainframe computers, and the like. Such methods may also be practiced in distributed computing environments where tasks are performed by local and remote processing devices that are linked (cither by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative Statements of the disclosure include:

Statement 1: A method comprising: initiating transmission of acoustic pulses based on operation of a hydrophone sensing apparatus deployed in a wellbore, wherein energy of the acoustic pulses moves along a wellbore casing according to a first acoustic wave mode after the transmitted acoustic pulses impact the wellbore casing; and receiving sensor data based on the operation of the hydrophone sensing apparatus, wherein: a first portion of the sensor data corresponds to the first acoustic wave mode based on energy of the acoustic pulses moving along the wellbore according to the first acoustic wave mode, and other portions of the sensor data correspond to one or more other acoustic wave modes. This method may also include identifying an adaptive time/slowness window that associates the first portion of the sensor data that corresponds to the first acoustic wave mode with time; separating the first portion of the sensor data from the other portions of sensor data based on: the correspondence of the other portions of the sensor data with the one or more other wave modes, and the adaptive time/slowness window that associates the first portion of the sensor data that corresponds to the first acoustic wave mode with time; identifying a bond index value to associate with the wellbore based on an analysis of the data indicative of the energy of the acoustic pulses that move along the wellbore according to the first acoustic wave mode; and identifying that the bond index value meets a threshold level, wherein the wellbore is placed into operation based on the identification that the bond index value meets the threshold level.

Statement 2: The method of statement 1, further comprising: identifying changes in arrival times associated with a tube across an azimuth of the hydrophone sensing apparatus, wherein the changes in the arrival times correspond to an eccentricity of the tube; identifying an adaptive time/slowness window to associate with the tube; and adjusting the adaptive time/slowness window associated with the tube to compensate for the eccentricity of the tube, wherein the first acoustic wave mode is associated with a time and the azimuth of the hydrophone sensing apparatus.

Statement 3: The method of statement 1 or 2, wherein the first acoustic wave mode is associated with a velocity that the acoustic pulses that move along the wellbore casing according to the first acoustic wave mode.

Statement 4: The method of any of statements 1 through 3, wherein a slowness value of the first acoustic wave mode is proportional to the inverse of a/the velocity that the acoustic pulses that move along the wellbore casing according to the first acoustic.

Statement 5: The method of any of statements 1 through 4, further comprising identifying a range of slowness values and a range of time values of the first portion of the sensor data, wherein then first portion of sensor data includes respective data samples that each have a slowness value and a time value within the adaptive time/slowness window based on the adaptive time/slowness window being bounded by the range of slowness values and the range of time values.

Statement 6: The method of any of statements 1 through 5, further comprising generating a mapping that places each of the respective data samples within the adaptive time/slowness window.

Statement 7: The method of any of statements 1 through 6, further comprising identifying that a plurality of bond index values of the wellbore meet or exceed the threshold level; and identifying that the wellbore is safe to operate based on the identification that the plurality of bond index values of the wellbore meet or exceed the threshold level.

Statement 8: A system comprising a hydrophone sensing apparatus deployed in a wellbore; a memory; and one or more processors that execute instructions out of the memory to: initiate transmission of acoustic pulses based on operation of the hydrophone sensing apparatus, wherein energy of the acoustic pulses moves along a wellbore casing according to a first acoustic wave mode after the transmitted acoustic pulses impact the wellbore casing. The one or more processors may also execute the instructions to receive sensor data based on the operation of the hydrophone sensing apparatus, wherein: a first portion of the sensor data corresponds to the first acoustic wave mode based on energy of the acoustic pulses moving along the wellbore according to the first acoustic wave mode, and other portions of the sensor data correspond to one or more other acoustic wave modes. The one or more processors may then execute the instructions to identify an adaptive time/slowness window that associates the first portion of the sensor data that corresponds to the first acoustic wave mode with time; separate the first portion of the sensor data from the other portions of sensor data based on: the correspondence of the other portions of the sensor data with the one or more other wave modes, and the adaptive time/slowness window that associates the first portion of the sensor data that corresponds to the first acoustic wave mode with time. Next the one or more processors may execute the instructions to identify a bond index value to associate with the wellbore based on an analysis of the data indicative of the energy of the acoustic pulses that move along the wellbore according to the first acoustic wave mode; and identify that the bond index value meets a threshold level, wherein the wellbore is placed into operation based on the identification that the bond index value meets the threshold level.

Statement 9: The system of statement 8, wherein the first acoustic wave mode is associated with a time and an azimuth of the hydrophone sensing apparatus.

Statement 10: The system of statement 8 or 9, wherein the first acoustic wave mode is associated with a velocity that the acoustic pulses that move along the wellbore casing according to the first acoustic wave mode.

Statement 11: The system of any of statements 8 through 10, wherein a slowness value of the first acoustic wave mode is proportional to the inverse of a/the velocity that the acoustic pulses that move along the wellbore casing according to the first acoustic.

Statement 12: The system of any of statements 8 through 11, wherein the one or more processors execute the instructions to: identify a range of slowness values and a range of time values of the first portion of the sensor data, wherein then first portion of sensor data includes respective data samples that each have a slowness value and a time value within the adaptive time/slowness window based on the adaptive time/slowness window being bounded by the range of slowness values and the range of time values.

Statement 13: The system of any of statements 8 through 13, wherein the one or more processors execute the instructions to generate a mapping that places each of the respective data samples within the adaptive time/slowness window.

Statement 14: The system of any of statements 8 through 13, wherein the one or more processors execute the instructions to: identify that a plurality of bond index values of the wellbore meet or exceed the threshold level; and identify that the wellbore is safe to operate based on the identification that the plurality of bond index values of the wellbore meet or exceed the threshold level.

Statement 15: A non-transitory computer-readable storage medium having embodied thereon instructions that when executed by one or more processors cause the one or more processors to: initiate transmission of acoustic pulses based on operation of a hydrophone sensing apparatus deployed in a wellbore, wherein energy of the acoustic pulses moves along a wellbore casing according to a first acoustic wave mode after the transmitted acoustic pulses impact the wellbore casing; and receive sensor data based on the operation of the hydrophone sensing apparatus, wherein: a first portion of the sensor data corresponds to the first acoustic wave mode based on energy of the acoustic pulses moving along the wellbore according to the first acoustic wave mode, and other portions of the sensor data correspond to one or more other acoustic wave modes. The one or more processors may execute the instructions to identify an adaptive time/slowness window that associates the first portion of the sensor data that corresponds to the first acoustic wave mode with time; and separate the first portion of the sensor data from the other portions of sensor data based on: the correspondence of the other portions of the sensor data with the one or more other wave modes, and the adaptive time/slowness window that associates the first portion of the sensor data that corresponds to the first acoustic wave mode with time. Additional instructions may be executed by the one or more processors to identify a bond index value to associate with the wellbore based on an analysis of the data indicative of the energy of the acoustic pulses that move along the wellbore according to the first acoustic wave mode; and identify that the bond index value meets a threshold level, wherein the wellbore is placed into operation based on the identification that the bond index value meets the threshold level.

Statement 16: The non-transitory computer-readable storage medium of statement 15, wherein the first acoustic wave mode is associated with a time and an azimuth of the hydrophone sensing apparatus.

Statement 17: The non-transitory computer-readable storage medium of statement 15 or 16, wherein the first acoustic wave mode is associated with a velocity that the acoustic pulses that move along the wellbore casing according to the first acoustic wave mode.

Statement 18: The non-transitory computer-readable storage medium of any of statements 1 through 17, wherein a slowness value of the first acoustic wave mode is proportional to the inverse of a/the velocity that the acoustic pulses that move along the wellbore casing according to the first acoustic.

Statement 19: The non-transitory computer-readable storage medium of any of statements 1 through 18, wherein the one or more processors execute the instructions to identify a range of slowness values and a range of time values of the first portion of the sensor data, wherein then first portion of sensor data includes respective data samples that each have a slowness value and a time value within the adaptive time/slowness window based on the adaptive time/slowness window being bounded by the range of slowness values and the range of time values.

Statement 20: The non-transitory computer-readable storage medium of any of statements 1 through 19, wherein the one or more processors execute the instructions to generate a mapping that places each of the respective data samples within the adaptive time/slowness window.

What is claimed is:

1. A method comprising:
initiating transmission of acoustic pulses based on operation of a hydrophone sensing apparatus deployed in a wellbore, wherein energy of the acoustic pulses moves along a wellbore casing according to a first acoustic wave mode after the transmitted acoustic pulses impact the wellbore casing;
receiving sensor data based on the operation of the hydrophone sensing apparatus, wherein:
a first portion of the sensor data corresponds to the first acoustic wave mode based on energy of the acoustic pulses moving along the wellbore according to the first acoustic wave mode, and
other portions of the sensor data correspond to one or more other acoustic wave modes;
identifying an adaptive time/slowness window that associates the first portion of the sensor data that corresponds to the first acoustic wave mode with time;
separating the first portion of the sensor data from the other portions of sensor data based on:
the correspondence of the other portions of the sensor data with the one or more other wave modes, and
the adaptive time/slowness window that associates the first portion of the sensor data that corresponds to the first acoustic wave mode with time;
identifying a bond index value to associate with the wellbore based on an analysis of the data indicative of the energy of the acoustic pulses that move along the wellbore according to the first acoustic wave mode; and
identifying that the bond index value meets a threshold level, wherein the wellbore is placed into operation based on the identification that the bond index value meets the threshold level.

2. The method of claim 1, further comprising:
identifying changes in arrival times associated with a tube across an azimuth of the hydrophone sensing apparatus, wherein the changes in the arrival times correspond to an eccentricity of the tube;
identifying an adaptive time/slowness window to associate with the tube; and
adjusting the adaptive time/slowness window associated with the tube to compensate for the eccentricity of the tube, wherein the first acoustic wave mode is associated with a time and the azimuth of the hydrophone sensing apparatus.

3. The method of claim 1, wherein the first acoustic wave mode is associated with a velocity that the acoustic pulses that move along the wellbore casing according to the first acoustic wave mode.

4. The method of claim 3, wherein a slowness value of the first acoustic wave mode is proportional to the inverse of the velocity that the acoustic pulses that move along the wellbore casing according to the first acoustic.

5. The method of claim 1, further comprising:
identifying a range of slowness values and a range of time values of the first portion of the sensor data, wherein then first portion of sensor data includes respective data samples that each have a slowness value and a time value within the adaptive time/slowness window based on the adaptive time/slowness window being bounded by the range of slowness values and the range of time values.

6. The method of claim 5, further comprising:
generating a mapping that places each of the respective data samples within the adaptive time/slowness window.

7. The method of claim 1, further comprising:
identifying that a plurality of bond index values of the wellbore meet or exceed the threshold level; and
identifying that the wellbore is safe to operate based on the identification that the plurality of bond index values of the wellbore meet or exceed the threshold level.

8. A system comprising:
a hydrophone sensing apparatus deployed in a wellbore;
a memory; and
one or more processors that execute instructions out of the memory to:
initiate transmission of acoustic pulses based on operation of the hydrophone sensing apparatus, wherein energy of the acoustic pulses moves along a wellbore casing according to a first acoustic wave mode after the transmitted acoustic pulses impact the wellbore casing;
receive sensor data based on the operation of the hydrophone sensing apparatus, wherein:
a first portion of the sensor data corresponds to the first acoustic wave mode based on energy of the acoustic pulses moving along the wellbore according to the first acoustic wave mode, and
other portions of the sensor data correspond to one or more other acoustic wave modes;
identify an adaptive time/slowness window that associates the first portion of the sensor data that corresponds to the first acoustic wave mode with time;
separate the first portion of the sensor data from the other portions of sensor data based on:
the correspondence of the other portions of the sensor data with the one or more other wave modes, and
the adaptive time/slowness window that associates the first portion of the sensor data that corresponds to the first acoustic wave mode with time;
identify a bond index value to associate with the wellbore based on an analysis of the data indicative of the energy of the acoustic pulses that move along the wellbore according to the first acoustic wave mode; and
identify that the bond index value meets a threshold level, wherein the wellbore is placed into operation based on the identification that the bond index value meets the threshold level.

9. The system of claim 8, wherein the first acoustic wave mode is associated with a time and an azimuth of the hydrophone sensing apparatus.

10. The system of claim 8, wherein the first acoustic wave mode is associated with a velocity that the acoustic pulses that move along the wellbore casing according to the first acoustic wave mode.

11. The system of claim 10, wherein a slowness value of the first acoustic wave mode is proportional to the inverse of the velocity that the acoustic pulses that move along the wellbore casing according to the first acoustic.

12. The system of claim 8, wherein the one or more processors execute the instructions to:
identify a range of slowness values and a range of time values of the first portion of the sensor data, wherein then first portion of sensor data includes respective data samples that each have a slowness value and a time value within the adaptive time/slowness window based on the adaptive time/slowness window being bounded by the range of slowness values and the range of time values.

13. The system of claim 12, wherein the one or more processors execute the instructions to generate a mapping that places each of the respective data samples within the adaptive time/slowness window.

14. The system of claim 8, wherein the one or more processors execute the instructions to:
identify that a plurality of bond index values of the wellbore meet or exceed the threshold level; and
identify that the wellbore is safe to operate based on the identification that the plurality of bond index values of the wellbore meet or exceed the threshold level.

15. A non-transitory computer-readable storage medium having embodied thereon instructions that when executed by one or more processors cause the one or more processors to:
initiate transmission of acoustic pulses based on operation of a hydrophone sensing apparatus deployed in a wellbore, wherein energy of the acoustic pulses moves along a wellbore casing according to a first acoustic wave mode after the transmitted acoustic pulses impact the wellbore casing;
receive sensor data based on the operation of the hydrophone sensing apparatus, wherein:
a first portion of the sensor data corresponds to the first acoustic wave mode based on energy of the acoustic pulses moving along the wellbore according to the first acoustic wave mode, and
other portions of the sensor data correspond to one or more other acoustic wave modes;
identify an adaptive time/slowness window that associates the first portion of the sensor data that corresponds to the first acoustic wave mode with time;
separate the first portion of the sensor data from the other portions of sensor data based on:
the correspondence of the other portions of the sensor data with the one or more other wave modes, and
the adaptive time/slowness window that associates the first portion of the sensor data that corresponds to the first acoustic wave mode with time;
identify a bond index value to associate with the wellbore based on an analysis of the data indicative of the energy of the acoustic pulses that move along the wellbore according to the first acoustic wave mode; and
identify that the bond index value meets a threshold level, wherein the wellbore is placed into operation based on the identification that the bond index value meets the threshold level.

16. The non-transitory computer-readable storage medium of claim 15, wherein the first acoustic wave mode is associated with a time and an azimuth of the hydrophone sensing apparatus.

17. The non-transitory computer-readable storage medium of claim 15, wherein the first acoustic wave mode is associated with a velocity that the acoustic pulses that move along the wellbore casing according to the first acoustic wave mode.

18. The non-transitory computer-readable storage medium of claim 17, wherein a slowness value of the first acoustic wave mode is proportional to the inverse of the velocity that the acoustic pulses that move along the wellbore casing according to the first acoustic.

19. The non-transitory computer-readable storage medium of claim 15, wherein the one or more processors execute the instructions to:
identify a range of slowness values and a range of time values of the first portion of the sensor data, wherein then first portion of sensor data includes respective data samples that each have a slowness value and a time value within the adaptive time/slowness window based on the adaptive time/slowness window being bounded by the range of slowness values and the range of time values.

20. The non-transitory computer-readable storage medium of claim 19, wherein the one or more processors execute the instructions to generate a mapping that places each of the respective data samples within the adaptive time/slowness window.
